(19) United States
(12) Patent Application Publication
(10) Pub. No.: US 2021/0286564 A1
(43) Pub. Date: Sep. 16, 2021

(54) NON-TRANSITORY RECORDING MEDIUM, INFORMATION PROCESSING APPARATUS, AND PRINT CONTROL METHOD

(71) Applicant: KAZUHIRO MIYABE, Kanagawa (JP)

(72) Inventor: KAZUHIRO MIYABE, Kanagawa (JP)

(73) Assignee: Ricoh Company, Ltd., Tokyo (JP)

(21) Appl. No.: 17/192,056

(22) Filed: Mar. 4, 2021

(30) Foreign Application Priority Data
Mar. 10, 2020 (JP) 2020-041320

(51) Int. Cl. G06F 3/12

(52) U.S. Cl. CPC G06F 3/1205; G06F 3/1238; G06F 3/1276; G06F 3/1253

(57) ABSTRACT

A non-transitory recording medium, an information processing apparatus, and a print control method. The non-transitory recording medium storing instructions which, when executed by one or more processors of an information processing apparatus, cause the processors to determine whether a setting screen for receiving setting information related to a print process can be displayed on a display after the print process is started, display on the display the setting screen when the setting screen can be displayed and control the print process using the setting information received on the setting screen.

### CROSS-REFERENCE TO RELATED APPLICATIONS

This patent application is based on and claims priority pursuant to 35 U.S.C. § 119(a) to Japanese Patent Application No. 2020-041320, filed on Mar. 10, 2020, in the Japan Patent Office, the entire disclosure of which is hereby incorporated by reference herein.

### BACKGROUND

### Technical Field

The present disclosure relates to a non-transitory recording medium, an information processing apparatus, and a print control method.

### Related Art

In WINDOWS (registered trademark) Operating System (OS) from WINDOWS 2000 to WINDOWS 7, a printer driver architecture called Version 3 (hereinafter referred to as “V3”) printer driver is adopted. In WINDOWS 8 and later WINDOWS OS, in addition to the V3 printer driver, a new printer driver architecture called Version 4 (hereinafter referred to as “V4”) printer driver is adopted.

With the V3 printer driver installed, an information processing apparatus that enables a change of print settings after the start of printing regardless of difference in spool format and an installation environment of the printer driver is known.

### SUMMARY

Embodiments of the present disclosure describe a non-transitory recording medium, an information processing apparatus, and a print control method. The non-transitory recording medium storing instructions which, when executed by one or more processors of an information processing apparatus, cause the processors to determine whether a setting screen for receiving setting information related to a print process can be displayed on a display after the print process is started, display on the display the setting screen when the setting screen can be displayed and control the print process using the setting information received on the setting screen.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram illustrating a system configuration of an information processing system according to embodiments of the present disclosure;

FIG. 2 is a block diagram illustrating a hardware configuration of a computer according to embodiments of the present disclosure;

FIG. 3 is a block diagram illustrating a software configuration of a client according to embodiments of the present disclosure;

FIG. 4 is a diagram illustrating a storage area accessible by a V4 printer driver and a store device application;

FIG. 5 is a block diagram illustrating a functional configuration of a client according to embodiments of the present disclosure;

FIG. 6 is a flowchart illustrating an example of a printing process according to embodiments of the present disclosure;

FIG. 7 is a flowchart illustrating an example of a determination process according to embodiments of the present disclosure;

FIG. 8 is a flowchart illustrating an example of a printing process according to a first embodiment of the present disclosure;

FIG. 9 is a diagram illustrating an example of a setting screen according to the first embodiment of the present disclosure;

FIG. 10 is a diagram illustrating an example of a selection screen according to the first embodiment of the present disclosure;

FIG. 11 is a block diagram illustrating an example of a system configuration of an information processing system, according to a second embodiment of the present disclosure; and

FIG. 12 is a flowchart illustrating an example of a printing process according to the second embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, a description is given of several embodiments of the present disclosure with reference to drawings.

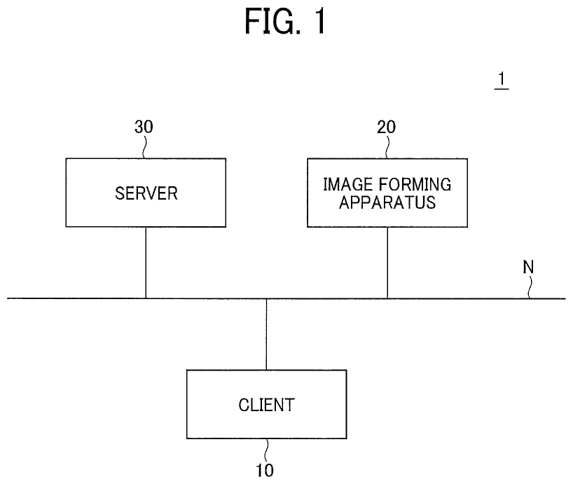

A system configuration of an information processing system 1 according to the present embodiment is described with reference to FIG. 1. FIG. 1 is a block diagram illustrating a system configuration of an information processing system according to the present embodiment.

As illustrated in FIG. 1, the information processing system 1 according to the present embodiment includes a client 10, an image forming apparatus 20, and a server 30 and these devices are connected so as to be able to communicate with each other through the network N such as a local area network (LAN).

The client 10 is an information processing apparatus such as a personal computer (PC) or a tablet terminal in which a printer driver, which is a program for controlling printing, is installed. For example, when the client 10 receives a print instruction from a user, the client 10 controls the print process by the printer driver.

Print target data is, for example, electronic data to be printed, such as image data and document data. Print data is, for example, the electronic data obtained by converting the print target data into a Page Description Language (PDL) format or the like that can be printed by the image forming apparatus 20.

The image forming apparatus 20 is an electronic device having a printing function such as a printer or a multifunction peripheral (MFP). The image forming apparatus 20 can print the print data received from the client 10, the server 30, and the like.

The server 30 is, for example, an information processing apparatus such as the PC. The server 30 includes, for example, a printer driver installed and includes a function of creating the print data from the print target data received from the client 10 and transmitting the created print data to the image forming apparatus 20.

The printer driver of WINDOWS OS has an installation format called “point and print”.

For example, as illustrated in FIG. 1, when the client 10, the image forming apparatus 20, and the server 30 are connected to the network N, the client 10 can print on the image forming apparatus 20 using the server 30 as a print server.

In such an information processing system 1, the same printer driver as the server 30 is installed in the client 10. However, if the same printer driver as the server 30 is individually installed on the plurality of client 10 on the network N, there is a drawback that the cost is high.

To solve such drawback, a printer driver can be downloaded from the server 30 to the client 10 and installed by using the point and print function provided by the WINDOWS OS.

In the point and print, “client side rendering” in which the print data is generated on the client 10 and “server side rendering” in which the print data is generated on the server 30 can be switched.

In the information processing system 1 as illustrated in FIG. 1, after printing is started by a printing operation or the like of a user who uses the client 10, there is a request to execute various functions (predetermined functions) that requires, for example, displaying a setting screen such as a pop-up window. The predetermined functions include, for example, an encryption function that encrypts the print data using a password entered on the setting screen, and a server storage function that stores the print data in a document server or the like using the information entered on the setting screen. In addition, the predetermined functions may include, for example, a preview function that displays a print preview on the setting screen and accepts changes in print settings, and a function of storing print data in the image forming apparatus 20 or the like using the information entered on the setting screen.

In order to implement such predetermined functions, for example, in a conventional system using a V3 (Version 3) printer driver, an original language monitor or a port monitor developed by a vendor or the like is used.

However, the original language monitor, or the port monitor, etc. developed by vendors, etc. cannot be used on the V4 printer driver due to restrictions of the OS. Therefore, there is a drawback that the V4 printer driver cannot implement the predetermined functions to be displayed on the setting screen after printing is started by the same method as the V3 printer driver.

Therefore, the client 10 confirms whether a setting print for entering the setting information to the user can be displayed in the V4 printer driver environment and when the setting print can be displayed, the client 10 displays the setting screen and controls the printing process based on the input setting information. As a result, the client 10 can implement various functions that require displaying the setting screen even after printing is started in the V4 printer driver. The specific processing content is described below.

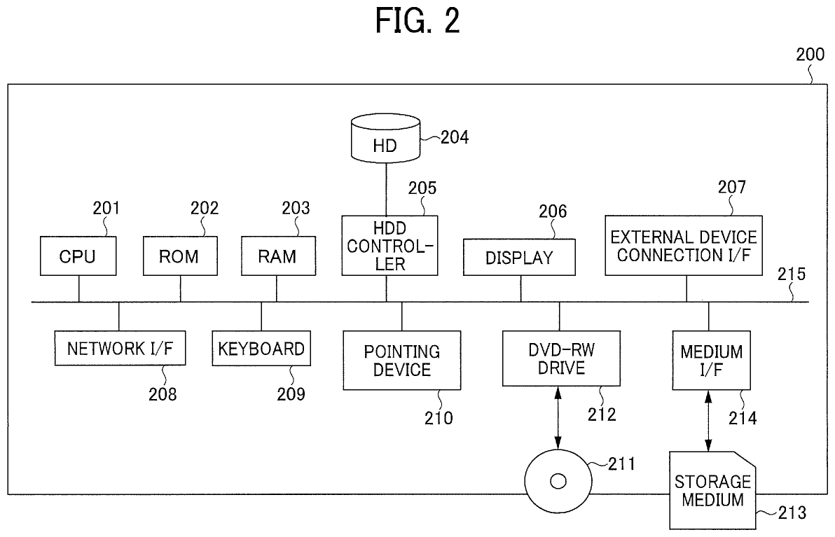

The client 10 and the server 30 are implemented by, for example, a hardware configuration of a computer 200 as illustrated in FIG. 2.

FIG. 2 is a block diagram illustrating the hardware configuration of the computer according to the present embodiment. The computer 200 includes, for example, a central processing unit (CPU) 201, a read only memory (ROM) 202, a random access memory (RAM) 203, a hard disk (HD) 204, a hard disk drive (HDD) controller 205, a display 206, an external device connection interface (I/F) 207, a network I/F 208, a keyboard 209, a pointing device 210, a digital versatile disk rewritable (DVD-RW) drive 212, a medium I/F 214, a bus line 215, and the like.

Among these elements, the CPU 201 controls entire operation of the computer 200. The ROM 202 stores a program used for driving the computer 200, such as an initial program loader (IPL). The RAM 203 is used as, for example, a work area for the CPU 201. The HD 204 stores various data such as a control program. The HDD controller 205 controls reading and writing of various data from and to the HD 204 under control of the CPU 201.

The display 206 displays various information such as a cursor, menu, window, character, or image. The external device connection I/F 207 is an interface for connecting various external devices. The external device includes, for example, a universal serial bus (USB) memory and the like. The network I/F 208 is an interface for performing data communication using the network N.

The keyboard 209 is an example of an input device provided with a plurality of keys for allowing a user to input characters, numerals, or various instructions. The pointing device 210 is an example of an input device that allows a user to select or execute a specific instruction, select a target for processing, or move a cursor being displayed. The DVD-RW drive 212 reads and writes various data from and to a DVD-RW 211, which is an example of a removable storage medium. The DVD-RW 211 is not limited to the DVD-RW and may be another recording medium. The medium I/F 214 controls reading or writing (storage) of data to a storage medium 213 such as a flash memory or a memory card. The bus line 215 includes an address bus, a data bus, various control signals, and the like for electrically connecting each of the above components.

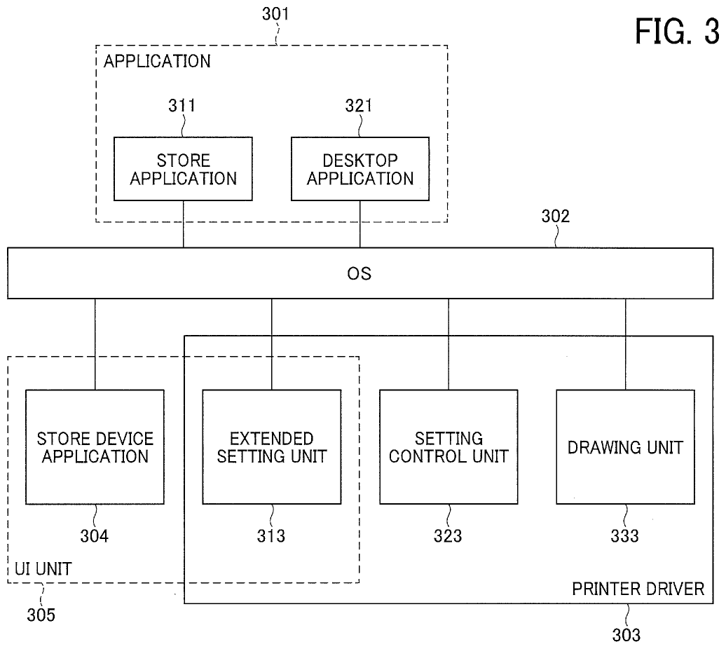

The client 10 is implemented by, for example, a software configuration as illustrated in FIG. 3.

FIG. 3 is a block diagram illustrating the software configuration of the client according to the present embodiment. As illustrated in FIG. 3, the client 10 according to the present embodiment includes an application 301, an OS 302, a printer driver 303, and a store device application 304.

The application 301 is application software that can issue an instruction (request) for printing to the OS 302 in response to a user's print instruction, such as document creation software, image viewing/editing software, a browser, and the like. The application 301 includes a store application 311 and a desktop application 321.

The store application 311 is an application that can be obtained from, for example, “WINDOWS Store” that provides applications to WINDOWS 8/WINDOWS RT and subsequent versions of WINDOWS OS. In the store application 311 a “store application user interface (UI)” is used. In WINDOWS 8 and WINDOWS 8.1, the store application 311 is called from a UI called “Modern UI” or “Metro UI” provided by the OS 302.

On the other hand, the desktop application 321 is an application that can be used also in, for example, WINDOWS 7 or earlier versions.

The OS 302 is WINDOWS 8/WINDOWS RT or later versions of WINDOWS OS.

The printer driver 303 is, for example, a V4 printer driver. The V4 printer driver includes, for example, an extended setting unit 313, a setting control unit 323, and a drawing unit 333, as illustrated in FIG. 3.

The extended setting unit 313 is also referred to as a printer extension. When printing is performed from the desktop application 321, the extended setting unit 313 displays a vendor specific customized print setting screen or the like.

The setting control unit 323 is also called a prohibition script, and verifies, for example, whether or not a combination of print settings is valid. The extended setting unit 313 can, for example, hide a combination of print settings that has been verified by the setting control unit 323 as invalid.

The drawing unit 333 creates print data from the print target data for which the print instruction is given in the application 301.

When printing is instructed from the store application 311, the store device application 304 displays the vendor specific print setting screen or the like. Note that the store device application 304 is an application that can be obtained from the “WINDOWS store” like the store application 311.

When printing is instructed from the desktop application 321, the printer driver 303 can generate the print data based on the print settings on the print setting screen displayed by the extended setting unit 313. On the other hand, when printing is instructed from the store application 311, the printer driver 303 can generate the print data based on the print settings on the print setting screen displayed by the store device application 304.

The extended setting unit 313 and the store device application 304 constitute a UI unit 305 that displays a vendor-specific print setting screen.

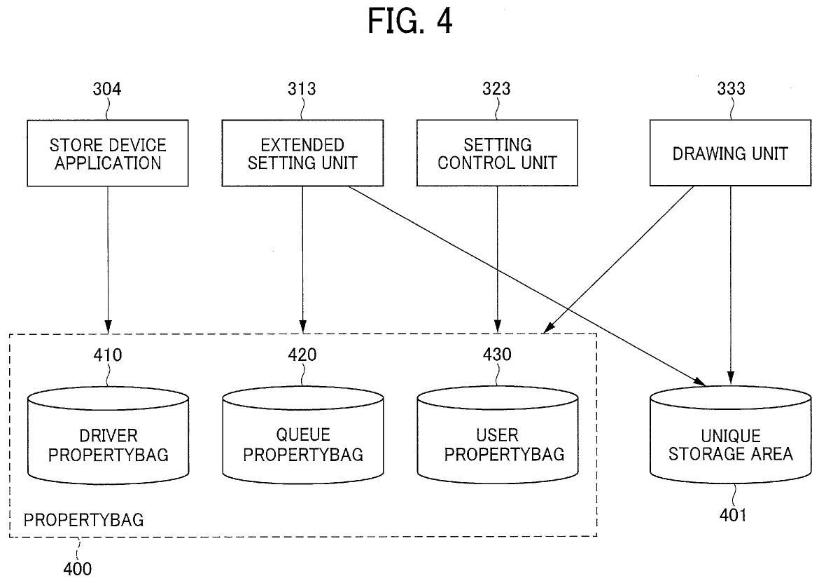

A storage area accessible by the V4 printer driver 303 and the store device application 304 is described with reference to FIG. 4. FIG. 4 is a diagram illustrating a storage area accessible by the V4 printer driver 303 and the store device application 304.

As illustrated in FIG. 4, the extended setting unit 313, the setting control unit 323, the drawing unit 333, and the store device application 304 can access a storage area called a property bag 400. Note that such access to the storage area can be performed using an application program interface (API) provided by the OS 302.

As illustrated in FIG. 4, the property bag 400 includes a driver property bag 410, a queue property bag 420, and a user property bag 430.

The driver property bag 410 is a storage area for storing configuration information and the like determined when the V4 printer driver 303 is created. The extended setting unit 313, the setting control unit 323, the drawing unit 333 and the store device application 304 are capable of reading various information from the driver property bag 410. On the other hand, the extended setting unit 313, the setting control unit 323, the drawing unit 333, and the store device application 304 cannot write information to the driver property bag 410.

The queue property bag 420 is a storage area for storing setting information and the like for each logical printer (printer icon). The extended setting unit 313 and the store device application 304 can read and write various kinds of information from and to the queue property bag 420. In addition, the setting control unit 323 and the drawing unit 333 can read various kinds of information from the queue property bag 420.

Note that the logical printer is, for example, a virtual printer displayed as a printer icon in a printer folder or the like of the OS 302. A user of the client 10 can create a plurality of logical printers having different setting information (for example, paper size, paper orientation, print quality, etc.) for one image forming apparatus 20.

The user property bag 430 is a storage area for storing setting information and the like for each user for each logical printer. The extended setting unit 313, the setting control unit 323, and the store device application 304 can read and write various kinds of information from and to the user property bag 430.

Further, the extended setting unit 313 and the drawing unit 333 can read and write various kinds of information from and to a unique storage area 401.

The unique storage area 401 is implemented by using, for example, a registry, a file, or the like, and is a storage area different from the property bag 400. The unique storage area 401 is defined by the vendor providing the V4 printer driver 303 or the like.

The store device application 304 cannot access any storage area other than the property bag 400 due to constraints imposed by the OS 302. Further, the setting control unit 323 cannot access any storage areas other than the property bag 400 described above. That is, the store device application 304 and the setting control unit 323 cannot read or write various information from or to the unique storage area 401.

This is the same as the constraint imposed on the store application 311, and is meant to prevent, for example, the store device application 304 and the setting control unit 323 from changing the registry, etc. used by the OS 302 and adversely affecting the operation of the OS 302. Such a technique is called “sandboxing”.

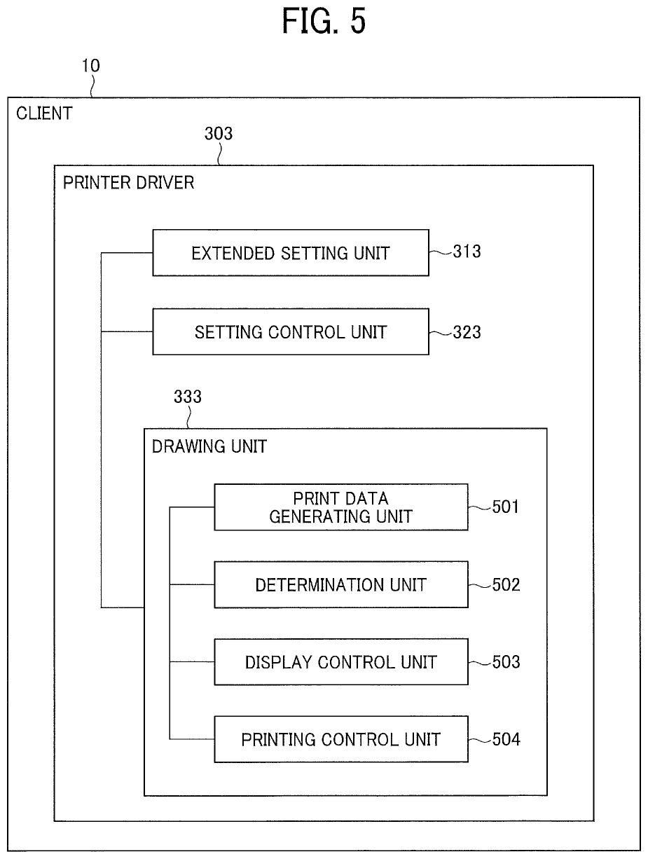

FIG. 5 is a block diagram illustrating a functional configuration of the client 10 according to the present embodiment. For example, the client 10 implements the extended setting unit 313, the setting control unit 323, the drawing unit 333, and the like by the CPU 201 of FIG. 2 executing the printer driver 303, which is a V4 printer driver. In the present embodiment, the extended setting unit 313 and the setting control unit 323 may have the same configuration as a general V4 printer driver, and thus the description thereof is omitted here.

The drawing unit 333 according to the present embodiment includes, for example, a print data generating unit 501, a determination unit 502, a display control unit 503, a printing control unit 504, and the like.

The print data generating unit 501 generates print data that can be printed by the image forming apparatus 20 based on, for example, print target data included in a print command notified from OS 302 and print setting information (PrintTicket or the like). The function of the print data generating unit 501 may be the same as the function of the drawing unit 333 of a general V4 printer driver.

The determination unit 502 executes a determination process for determining whether or not the setting screen for entering the setting information related to the print process can be displayed after the client 10 starts the print process.

For example, the determination unit 502 determines whether or not the printer driver 303 is a printer driver installed by the point and print function. Further, when the printer driver 303 is a printer driver installed by the point and print function, the determination unit 502 determines whether the printer driver is the client side rendering, or the server side rendering described above.

Further, the determination unit 502 determines that the setting screen can be displayed when the printer driver 303 is a printer driver installed by the point and print function and is client side rendering. Further, the determination unit 502 determines that the setting screen can be displayed when the printer driver 303 is not the printer driver installed by the point and print function. In this way, the determination unit 502 determines that the print data generating unit 501 of the client 10 can display the setting screen when the print data is generated.

On the other hand, the determination unit 502 determines that the setting screen cannot be displayed when the printer driver 303 is a printer driver installed by the point and print function and is server side rendering. In this way, the determination unit 502 determines that the setting screen cannot be displayed if the print data generating unit 501 of the client 10 does not generate print data.

When the determination unit 502 determines that the setting screen can be displayed, the display control unit 503 executes a display process to display the setting screen for entering the setting information related to the print process and to receive the setting information entered by the user.

Further, when the determination unit 502 determines that the setting screen cannot be displayed, the display control unit 503 displays a selection screen for selecting whether to execute the print process without executing a predetermined function, or to cancel the print process and receives a user's selection operation.

The printing control unit 504 executes a print control process for controlling the print process by using the setting information entered by the user on the setting screen displayed by the display control unit 503.

For example, the print process controlled by the printing control unit 504 includes an encryption function that encrypts the print data by using the user password entered on the setting screen. In this case, the display control unit 503 displays the setting screen for entering the user password (an example of setting information related to the print process) and receives the password entered by the user. Further, the printing control unit 504 encrypts the print data using the password entered on the setting screen and transmits the print data to the server 30, the image forming apparatus 20, or the like through, for example, the OS 302.

As another example, in the print process controlled by the printing control unit 504, a print job registration function for registering a print job in the document server, the image forming apparatus 20, or the like using the setting information set on the setting screen is included. In this case, the display control unit 503 displays a setting screen for entering the setting information (for example, user ID, password, etc.) for registering the print job on the document server, the image forming apparatus 20, or the like, and receives the setting information entered by the user. Further, the printing control unit 504 creates the print job including the print data, print setting information, the user ID for identifying the user, and the like by using the setting information entered on the setting screen, creates the print job via, for example, OS 302 and registers in the document server, the image forming apparatus 20, or the like, for example, through the OS 302.

As described above, in the client 10 according to the present embodiment, the drawing unit 333 of the printer driver 303 executes the predetermined function by using the display process of displaying the setting screen and receiving the setting information and the print control process that executes the predetermined function using the setting information. Therefore, unlike the conventional technique, for example, the setting screen is displayed after printing is started without using an original language monitor, port monitor, or the like and the settings of the print process can be changed.

Further, the client 10 according to the present embodiment determines whether or not the setting screen can be displayed, that is, whether or not the setting information entered on the setting screen can be reflected in the print data and displays the setting screen when the setting screen can be displayed. Therefore, the client 10 can display the setting screen only when the setting information entered on the setting screen can be reflected in the print data.

Further, when the setting screen cannot be displayed, the client 10 can display the selection screen for selecting whether to continue the print process without executing the predetermined function or to cancel the print process.

An information processing method according to the present embodiment is described below.

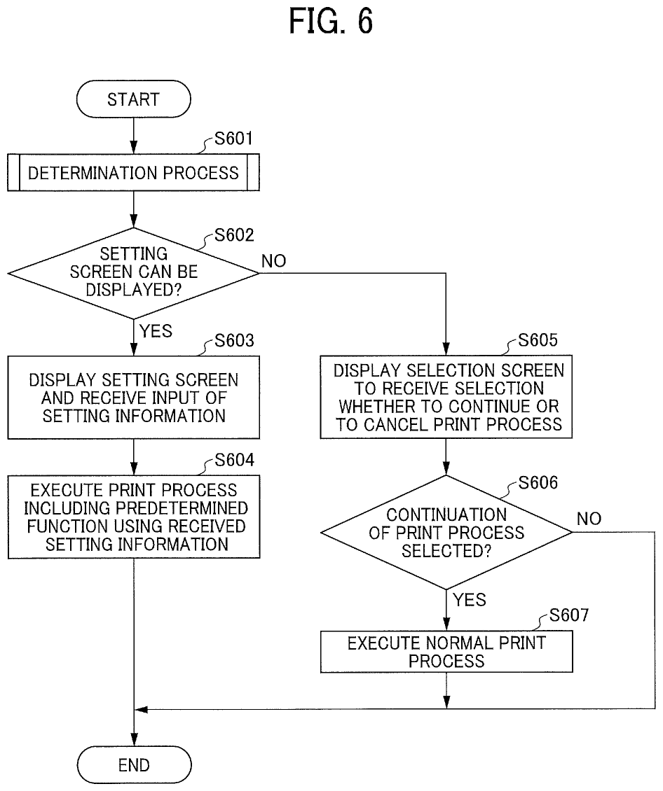

FIG. 6 is a flowchart illustrating an example of the print process according to the present embodiment. The flowchart describes an outline of the print process executed by the client 10.

In step S601, the determination unit 502 of the client 10 executes a determination process for determining whether or not the setting screen for entering the setting information related to the print process can be displayed after starting the print process. The processing content of the determination process is described below.

In step S602, the display control unit 503 of the client 10 branches the process depending on whether or not the determination unit 502 determined that the setting screen can be displayed. When the determination unit 502 determines that the setting screen can be displayed, the display control unit 503 shifts the process to step S603. On the other hand, when the determination unit 502 determines that the setting screen cannot be displayed, the display control unit 503 shifts the process to step S605.

When the process proceeds to step S603, the display control unit 503 displays a setting screen for receiving the setting operation by the user on, for example, a display 206, and receives the setting information entered by the user.

In step S604, the printing control unit 504 of the client 10 uses the setting information entered on the setting screen to perform the predetermined function (for example, encryption of the print data) on the print data generated by the print data generating unit 501 and controls the print process.

On the other hand, when the process proceeds from step S602 to step S605, the display control unit 503 displays the selection screen for selecting whether to continue the print process or cancel the print process on, for example, the display 206, and receives the selection operation by the user.

In step S606, the printing control unit 504 of the client 10 determines whether or not continuation of print process is selected. When the continuation of print process is selected, the printing control unit 504 shifts the process to step S607. On the other hand, when the print process is canceled, the printing control unit 504 skips the process of step S607 and ends the process of FIG. 6.

When the process proceeds to step S607, the printing control unit 504 executes a normal print process.

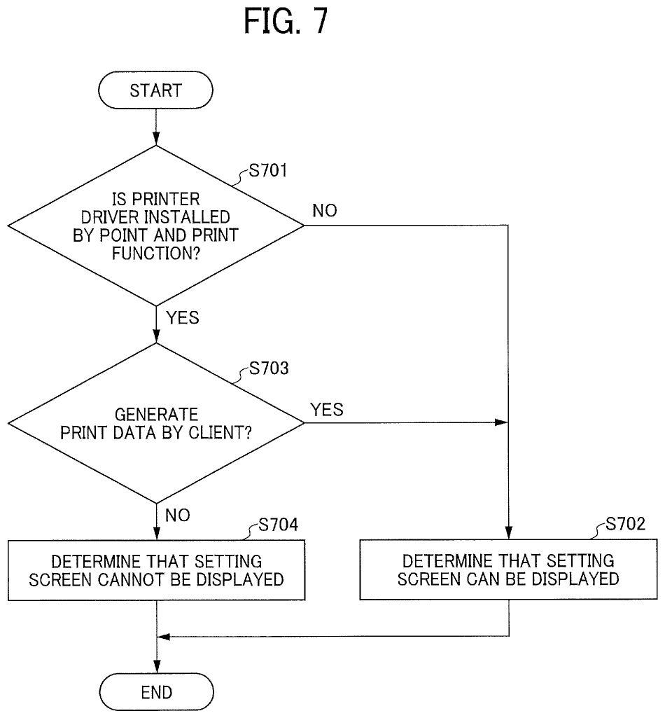

FIG. 7 is a flowchart illustrating an example of a determination process according to the present embodiment. The flowchart in FIG. 7 illustrates an example of the determination process executed by the determination unit 502 of the client 10 in step S601 of FIG. 6.

In step S701, the determination unit 502 determines whether or not the printer driver 303 is installed by the point and print function. If the printer driver 303 is not installed by the point and print function, the determination unit 502 proceeds the process to step S702. On the other hand, when the printer driver 303 is installed by the point and print function, the determination unit 502 proceeds the process to step S703.

When the process proceeds to step S702, the determination unit 702 determines that the setting screen can be displayed.

On the other hand, when the process proceeds to step S703, the determination unit 502 determines whether or not to generate the print data on the client 10. For example, the determination unit 502 determines whether the point and print setting is the client side rendering in which the print data is generated on the client 10 or the server side rendering in which the print data is generated on the server 30.

When the client 10 generates the print data, that is, when the setting is the client side rendering, the determination unit 502 proceeds the process to step S702 and determines that the setting screen can be displayed.

On the other hand, when the client 10 does not generate the print data, that is, when the setting is the server side rendering, the determination unit 502 proceeds the process to step S704 and determines that the setting screen cannot be displayed.

The above process is an example of the determination process executed by the determination unit 502. For example, the determination unit 502 may determine that the setting screen can be displayed when the print data generating unit 501 of the client 10 generates the print data and may determine that the setting screen cannot be displayed when the print data generating unit 501 does not generate the print data.

By the processing of FIGS. 6 and 7, the client 10 determines whether or not the setting screen can be displayed in the V4 printer driver environment, and if possible, displays the setting screen and the printing process can be executed based on the setting information that is entered.

Subsequently, more specific examples of the printing process is described by exemplifying first and second embodiments.

In the first embodiment, an example of the print process in the case where the predetermined function for displaying the setting screen after starting printing is the encryption function for encrypting the print data is described.

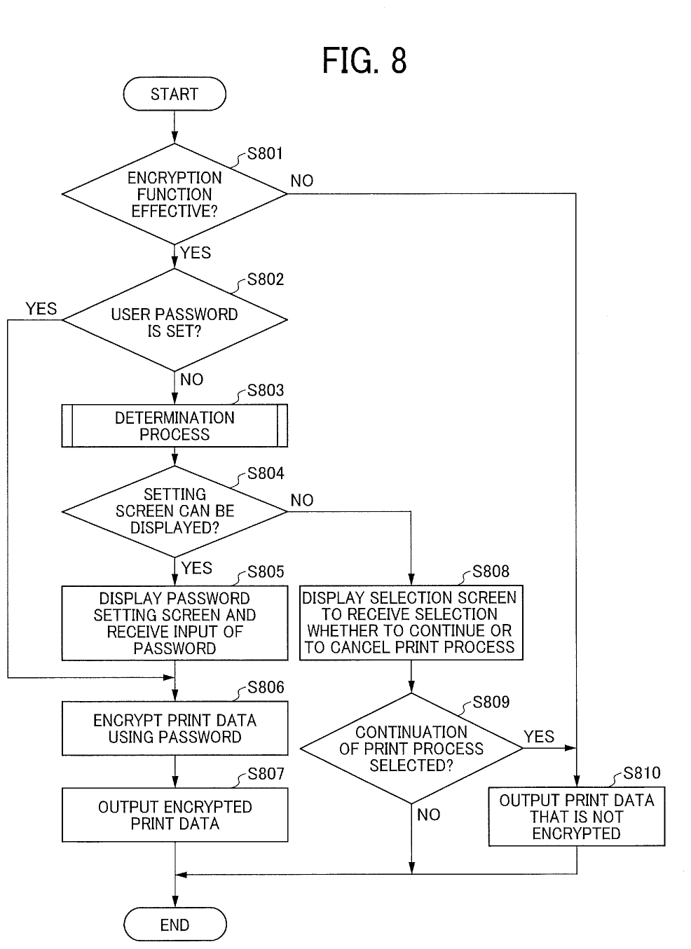

FIG. 8 is a flowchart illustrating an example of the print process according to the first embodiment of the present disclosure.

In step S801, the determination unit 502 of the client 10 determines whether or not the encryption function is effective. For example, the determination unit 502 determines whether or not the encryption function is set to “effective” in the print setting information among the print target data and the print setting information (PrintTicket, etc.) included in a print instruction notified from the OS 302.

When the encryption function is “effective”, the determination unit 502 proceeds the process to step S802. On the other hand, when the encryption function is “not effective”, the determination unit 502 proceeds the process to step S810.

When the process proceeds to step S802, the determination unit 502 determines whether or not the user password is set. For example, the determination unit 502 determines whether or not the user password is set in the print setting information included in the print instruction notified from the OS 302.

If the user password is not set, the determination unit 502 shifts the process to step S803. On the other hand, if the user password is set, the determination unit 502 shifts the process to step S806.

In step S803, the determination unit 502 determines whether or not the setting screen (for example, a pop-up screen or the like) for entering the user password can be displayed. For example, the determination unit 502 executes the determination process described in FIG. 7.

In step S804, the display control unit 503 of the client 10 branches the process depending on whether or not the determination unit 502 determined that the setting screen can be displayed. When the determination unit 502 determined that the setting screen can be displayed, the display control unit 503 shifts the process to step S805. On the other hand, when the determination unit 502 determined that the setting screen cannot be displayed, the display control unit 503 shifts the process to step S808.

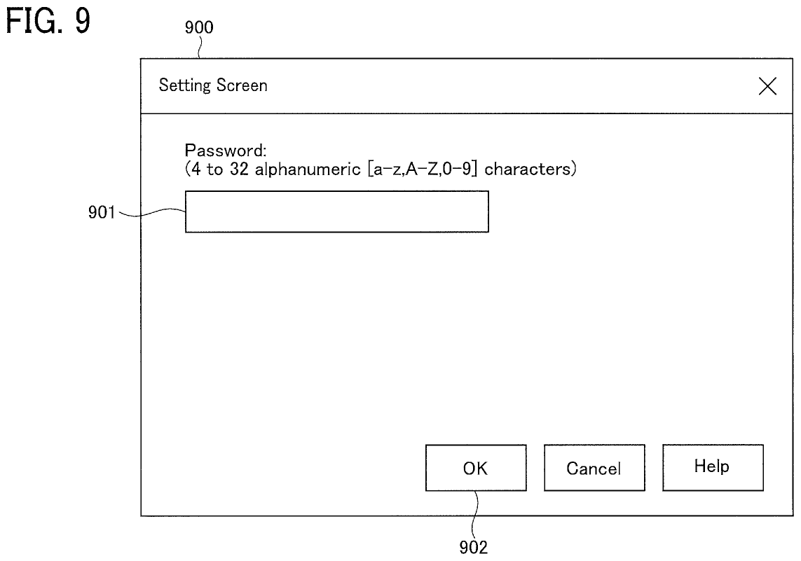

When the process proceeds to step S805, the display control unit 503 displays, for example, a password setting screen 900 as illustrated in FIG. 9 on the display 206 or the like and receives the input of the password from the user.

FIG. 9 is a diagram illustrating an example of the setting screen according to the first embodiment of the present disclosure. In the example of FIG. 9, a password setting field 901 is displayed on the password setting screen 900. The user can set the password by entering the password in the password setting field 901 and selecting an OK button 902.

When the process proceeds to step S806, the printing control unit 504 of the client 10 encrypts the print data generated by the print data generating unit 501 by using the user password set in step S805 or the user password set in advance.

In step S807, the printing control unit 504 outputs the encrypted print data. For example, the printing control unit 504 transmits the encrypted print data to the server 30, the image forming apparatus 20, and the like through the OS 302.

On the other hand, when the process proceeds from step S804 to step S808, the display control unit 503 displays the selection screen on the display 206 or the like for selecting whether to continue the print process without encryption or to cancel the print process and receives a selection operation from the user.

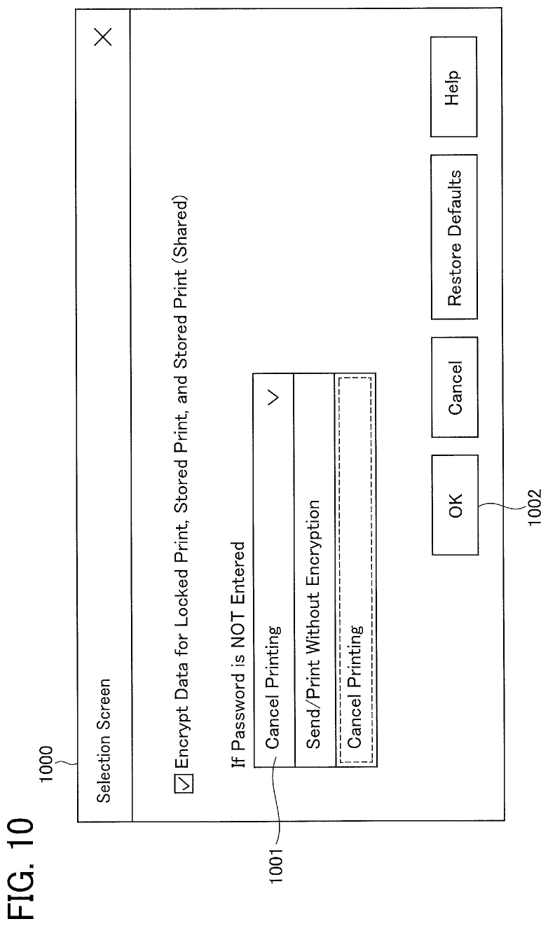

FIG. 10 illustrates an example of a selection screen 1000 displayed by the display control unit 503 in step S804. In the example of FIG. 10, a pull-down menu 1001 for selecting whether to continue the print process without encryption or to cancel the print process is displayed on the selection screen 1000. The user can instruct the client 10 whether or not to continue the process by selecting whether or not to continue the print process in the pull-down menu 1001 and selecting the OK button 1200.

In step S809, the printing control unit 504 of the client 10 branches the process depending on whether or not the user has selected to continue the print process. When the user selects to continue the print process, the printing control unit 504 proceeds the process to step S810. On the other hand, when the user selects to cancel the print process, the printing control unit 504 skips the process in step S810 and ends the process illustrated in FIG. 8.

When the process proceeds to step S810, the printing control unit 504 outputs unencrypted print data. For example, the printing control unit 504 transmits the unencrypted print data generated by the print data generating unit 501 to the server 30 or the image forming apparatus 20 through the OS 302.

By the above process, even in the V4 printer driver, the setting screen for entering the user password can be displayed after starting printing and the print data can be encrypted using the set password.

In the second embodiment, an example of the print process in a case where the predetermined function for displaying the setting screen after starting the printing is the printing data registration function for registering the print data in the document server or the like is described.

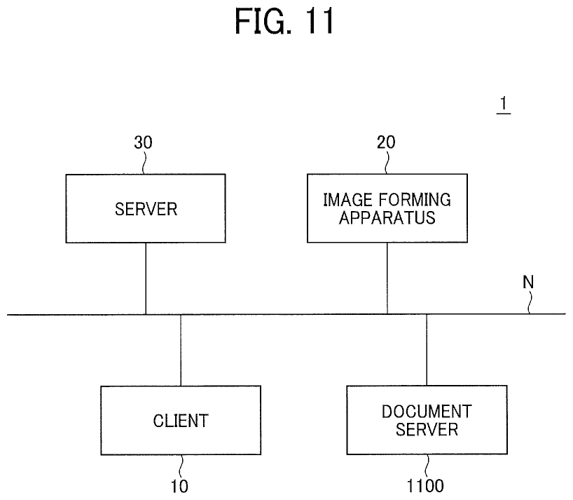

FIG. 11 is a block diagram illustrating an example of a system configuration of the information processing system according to the second embodiment of the present disclosure. As illustrated in FIG. 11, the information processing system 1 according to the second embodiment is implemented by a configuration in which the document server 1100 is added to the information processing system 1 according to the embodiment described with reference to FIG. 1.

The document server 1100 is, for example, an information processing apparatus having the configuration of the computer 200, or a system including a plurality of information processing apparatuses having the configuration of computers 200. For example, a user using the client 10 can register a print job including print data, print setting information, a user ID, and the like in the document server 1100.

Further, the user, for example, uses the image forming apparatus 20 to display a list of print jobs registered in the document server 1100 and selects a print job to be printed, so that the selected print job is printed by the image forming apparatus 20.

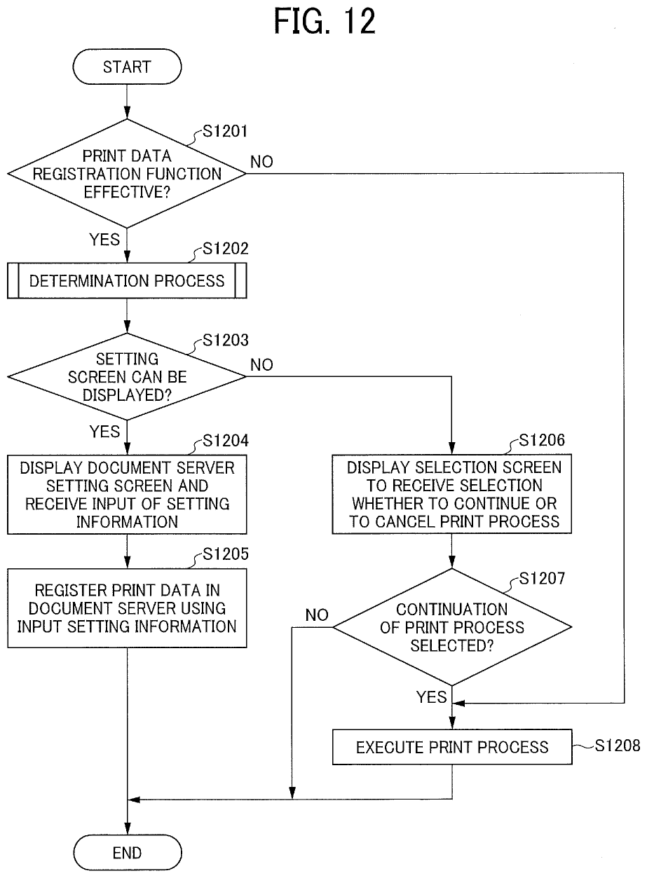

FIG. 12 is a flowchart illustrating an example of a print process according to the second embodiment of the present disclosure.

In step S1201, the determination unit 502 of the client 10 determines whether or not the print data registration function is effective. For example, the determination unit 502 determines whether or not the print data registration function is set to “effective” in the print setting information included in the print instruction notified from the OS 302.

When the print data registration function is “effective”, the determination unit 502 shifts the process to step S1202. On the other hand, when the print data registration function is “not effective”, the determination unit 502 shifts the process to step S1208.

When the process proceeds to step S1202, the determination unit 502 determines whether the setting screen for entering the setting information (for example, user ID, password of the document server 1100, etc.) necessary for registering the print job in the document server 1100 or the like can be displayed. For example, the determination unit 502 executes the determination process described in FIG. 7.

In step S1203, the display control unit 503 of the client 10 branches the process depending on whether or not the determination unit 502 determines that the setting screen can be displayed. When the determination unit 502 determines that the setting screen can be displayed, the display control unit 503 shifts the process to step S1204. On the other hand, when the determination unit 502 determines that the setting screen cannot be displayed, the display control unit 503 shifts the process to step S1206.

When the process proceeds to step S1204, the display control unit 503 displays the document server setting screen for setting the information necessary for registering the print job in the document server 1100 on the display 206 or the like and receives the user input of the setting information.

In step S1205, the printing control unit 504 of the client 10 registers the print job in the document server 1100 using the setting information (for example, user ID, password of the document server 1100, etc.) entered in step S1204. The print job includes, for example, the print data generated by the print data generating unit 501, the print setting information, the user ID that identifies the user, and the like.

On the other hand, when the process proceeds from step S1203 to step S1206, the display control unit 503 displays the selection screen for selecting whether to continue or cancel the print process on the display 206 or the like and receives a selection operation by the user.

In step S1207, the printing control unit 504 of the client 10 branches the process depending on whether or not the user has selected to continue the print process. When the user has selected to continue the print process, the printing control unit 504 proceeds the process to step S1208. On the other hand, when the user has selected to cancel the print process, the printing control unit 504 skips the process of step S1208 and ends the process of FIG. 12.

When the process proceeds to step S1208, the printing control unit 504 executes a normal print process. For example, the printing control unit 504 transmits the print data generated by the print data generating unit 501 to the server 30 or the image forming apparatus 20 through the OS 302.

As described above, the V4 printer driver is able to display the setting screen after starting printing and register the print job in the document server 1100 using the setting information entered on the setting screen.

In the above process, print data registration destination is the document server (an example of the external device) 1100, but the print data registration destination may be the image forming apparatus (another example of the external device) 20.

In this case, the display control unit 503 of the client 10 may display a setting screen for setting information (for example, a user ID that identifies the user) for registering print data in the image forming apparatus 20 in step S1204 of FIG. 12. Further, the printing control unit 504 may register the print job in the image forming apparatus 20 by using the setting information (user ID or the like) set on the setting screen in step S1205 of FIG. 12.

As described above, according to each embodiment of the present disclosure, in the V4 printer driver or the printer driver having the same limitation, the print setting screen or the like is displayed so that the settings of the print process can be changed after the print process is started.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. A non-transitory recording medium storing instructions which, when executed by one or more processors of an information processing apparatus, cause the processors to perform a print control method, the method comprising:
determining whether a setting screen for receiving setting information related to a print process can be displayed on a display after the print process is started;
displaying on the display the setting screen when the setting screen can be displayed; and
controlling the print process using the setting information received on the setting screen.

2. The non-transitory recording medium of claim 1, wherein
the determining determines that the setting screen can be displayed when the information processing apparatus generates print data for printing, and
the determining determines that the setting screen cannot be displayed when the information processing apparatus does not generate the print data for printing.

3. The non-transitory recording medium of claim 1, wherein
the determining determines that the setting screen can be displayed, when a printer driver is not installed by a point and print function, or when the printer driver is installed by the point and print function and the information processing apparatus generates print data for printing.

4. The non-transitory recording medium of claim 3, wherein
the determining determines that the setting screen cannot be displayed, when the printer driver is installed by the point and print function and the information processing apparatus does not generate the print data.

5. The non-transitory recording medium of claim 1, wherein the print control method comprises:
determining whether the setting screen can be displayed when one of predetermined functions that requires displaying the setting screen is effective.

6. The non-transitory recording medium of claim 5, wherein the print control method further comprises:
generating the print data; and
encrypting the print data based on the setting information received on the setting screen, in performing one of the predetermined functions.

7. The non-transitory recording medium of claim 5, wherein the print control method further comprises:
generating the print data; and
registering the print data in an external device based on the setting information received on the setting screen, in performing one of the predetermined functions.

8. The non-transitory recording medium of claim 1, wherein the print control method further comprises:
displaying on the display, a selection screen for receiving a selection of one of continuing the print process and cancelling the print process when the setting screen cannot be displayed.

9. An information processing apparatus comprising:
circuitry configured to:
determine whether a setting screen for receiving setting information related to a print process can be displayed on a display after the print process is started;
display the setting screen on the display when the setting screen can be displayed; and
control the print process using the setting information received on the setting screen.

10. The information processing apparatus of claim 9, wherein the circuitry is configured to:
determine that the setting screen can be displayed when the information processing apparatus generates print data for printing; and
determine that the setting screen cannot be displayed when the information processing apparatus does not generate the print data for printing.

11. The information processing apparatus of claim 9, wherein the circuitry is configured to:
determine whether the setting screen can be displayed when one of predetermined functions that requires displaying the setting screen is effective.

12. The information processing apparatus of claim 11, wherein the circuitry is configured to:
generate the print data; and
encrypt the print data based on the setting information received on the setting screen, in performing one of the predetermined functions.

13. The information processing apparatus of claim 11, wherein the circuitry is configured to:
generate the print data; and
register the print data in an external device based on the setting information received on the setting screen, in performing one of the predetermined functions.

14. The information processing apparatus of claim 9, wherein the circuitry is further configured to:
display on the display, a selection screen for receiving a selection of one of continuing the print process and cancelling the print process when the setting screen cannot be displayed.

15. A print control method executed by an information processing apparatus, the method comprising:
determining whether a setting screen for receiving setting information related to a print process can be displayed on a display after the print process is started;
displaying on the display the setting screen when the setting screen can be displayed; and
controlling the print process using the setting information received on the setting screen.

16. The print control method of claim 15, wherein
the determining determines that the setting screen can be displayed when the information processing apparatus generates print data for printing, and
the determining determines that the setting screen cannot be displayed when the information processing apparatus does not generate the print data for printing.

17. The print control method of claim 15, further comprising:
determining whether the setting screen can be displayed when one of predetermined functions that requires displaying the setting screen is effective.

18. The print control method of claim 17, further comprising:
generating the print data; and
encrypting the print data based on the setting information received on the setting screen, in performing one of the predetermined functions.

19. The print control method of claim 17, further comprising:
generating the print data; and
registering the print data in an external device based on the setting information received on the setting screen, in performing one of the predetermined functions.

20. The print control method of claim 15, further comprising:
displaying on a display, a selection screen for receiving a selection of one of continuing the print process and cancelling the print process when the setting screen cannot be displayed.
